(19) United States
(12) Patent Application Publication
(10) Pub. No.: US 2006/0263661 A1
(43) Pub. Date: Nov. 23, 2006

(54) PROTON CONDUCTOR AND ELECTROCHEMICAL DEVICE

(75) Inventors: Shuichi Takizawa, Tokyo (JP); Atsushi Nishimoto, Tokyo (JP); Kazuaki Fukushima, Tokyo (JP); Takuro Hirakimoto, Tokyo (JP); Kazuhiro Noda, Tokyo (JP)

Correspondence Address: BELL, BOYD & LLOYD, LLC, P. O. BOX 1135, CHICAGO, IL, 60690-1135, US

(73) Assignee: SONY CORPORATION, Tokyo (JP)

(21) Appl. No.: 11/426,474

(22) Filed: Jun. 26, 2006

(30) Foreign Application Priority Data
Feb. 13, 2004 (JP) P2004-035880

(51) Int. Cl. H01M 8/10

(52) U.S. Cl. 429/33; 429/314; 429/317

(57) ABSTRACT

A proton conductor is provided. The proton conductor includes a zwitterion salt such as MeImPrSO₃ and a proton (H⁺) donor such as HTFSI. An electrochemical device having a stacked layer structure formed of a first electrode, a second electrode and a proton conducting layer held between these electrodes, wherein the proton conducting layer includes a proton conductor according to the present invention. The present invention can, therefore, provide a proton conductor and electrochemical device, which can be suitably used in a dry state or under high-temperature, non-humidified conditions, can obviate a complex accessory such as a humidifier, and can simplify the system.

### CROSS REFERENCE TO RELATED APPLICATIONS

The present application claims priority to Japanese Patent Document No. P2004-035880 filed on Feb. 13, 2004, the disclosure of which is herein incorporated by reference.

### BACKGROUND

This invention relates to a proton conductor and an electrochemical device such as a fuel cell.

In a solid polymer fuel cell, water is generally used as a carrier for the conduction of protons (H⁺). The electrolyte membrane of the solid polymer fuel cell is, therefore, accompanied by a problem in that its output drops due to depletion of water in the membrane in a low-moisture atmosphere or in a high-temperature range of 100° C. and higher. To perform an operation at a stable output, it is, accordingly, necessary to establish a technology for water management.

At present, as methods for conducting the water management, there are the external humidification method, the internal humidification method, and the self-humidification method [see, for example, Japanese Patent Laid-open No. 2003-22829 (page 4, column 5, line 28 to page 6, column 10, line 46, FIG. 1 through FIG. 5), Japanese Patent Laid-open No. Hei 6-132038 (page 3, column 4, line 19 to page 4, column 5, line 36) and Japanese Patent Laid-open No. 2001-176529 (page 9, column 16, line 50 to page 10, column 18, line 40), all of which will be described subsequently herein].

It is considered possible to design small a proton conductor of a fuel cell system and hence to realize a size reduction and portabilization of the system, provided that the water management can be simplified.

For the simplification of the water management to achieve the portabilization of a fuel cell system, the external humidification method has a merit in that it facilitates the control of humidification and does not require any complex technology from the standpoint of materials. On the other hand, the external humidification method requires a space for additional equipment such as a humidifier, and the follow-up ability of its heating unit has developed a problem at the time of a high-speed start. The external humidification method is, therefore, not suited. The internal humidification method, on the other hand, is suited for portabilization, because it can quickly follow up changes in output owing to the replenishment of water adjacent to a polymer electrolyte membrane and it can design small the whole equipment owing to the assembly of a humidifier in a fuel cell. The self-humidification method makes use of a reaction which takes place during the operation of a fuel cell to effect the replenishment of water from the inside of a membrane. Therefore, the self-humidification method is the best in that it can omit additional equipment, and is suited for portabilization.

Under the current circumstances, however, the internal humidification method hardly permits a repair even when humidification is lowered for a certain cause or another, and the self-humidification method requires a new technology for the production of a membrane equipped with the desired performance. Accordingly, a new technology is needed for the simplification of the water management.

### SUMMARY

With the foregoing circumstances in view, an object of the present invention is to provide a proton conductor and electrochemical device, both of which can be suitably used even in a dry state or under high-temperature, non-humidified conditions, obviate complex additional equipment such as a humidifier, and can achieve the simplification of a system.

Described specifically, the present invention relates to a proton conductor including a zwitterion salt and a proton (H⁺) donor.

The present invention also relates to an electrochemical device having a stacked layer structure formed of a first electrode, a second electrode and a proton conducting layer held between these electrodes, in which the proton conducting layer includes the proton conductor according to the present invention.

Additional features and advantages of the present invention are described in, and will be apparent from, the following Detailed Description of the Invention and the figures.

### BRIEF DESCRIPTION OF THE FIGURES

FIG. 1 is a schematic cross-sectional view of an electrochemical device according to the present invention as constructed as a fuel cell according to one embodiment of the present invention.

FIG. 2 is a ¹H-NMR graph of MeImPrSO₃ in an example of the present invention.

FIG. 3 shows the results of a differential scanning calorimetry (DSC) measurement of a proton conductor according to the present invention and formed of MeImPrSO₃ and HTFSI in the example of the present invention.

FIG. 4 illustrates the results of a measurement of the chemical shift of the proton of HTFSI when the composition of the proton conductor was modified by changing the molar ratio of MeImPrSO₃ to HTFSI in the example of the present invention.

FIG. 5 is a Cole-Cole plot of the proton conductor according to the present invention (with the molar ratio of MeImPrSO₃ to HTFSI (MeImPrSO₃/HTFSI) having been set at 5/5) at room temperature (25° C.) in the example of the present invention.

FIG. 6 is a ¹H-NMR graph of HImPrSO₃ in another example of the present invention.

FIG. 7 shows the results of a differential scanning calorimetry (DSC) measurement of a proton conductor according to the present invention and formed of HImPrSO₃ and HTFSI in the another example of the present invention.

FIG. 8 illustrates the results of a measurement of the chemical shift of the proton of HTFSI when the composition of the proton conductor was modified by changing the molar ratio of HImPrSO₃ to HTFSI in the another example of the present invention.

FIG. 9 is a Cole-Cole plot of the proton conductor according to the present invention (with the molar ratio of HImPrSO₃ to HTFSI (HImPrSO₃/HTFSI) having been set at 5/5) at room temperature (25° C.) in the example of the present invention.

FIG. 10 shows the results of a measurement of a proton conductor according to the present invention, which was formed of “Nafion” (registered trademark) and MeImPrSO₃, at a constant voltage in a further example of the present invention.

### DETAILED DESCRIPTION

In the present invention, the zwitterion salt may desirably be a fusible salt represented by one of the following formulas (1) to (5):

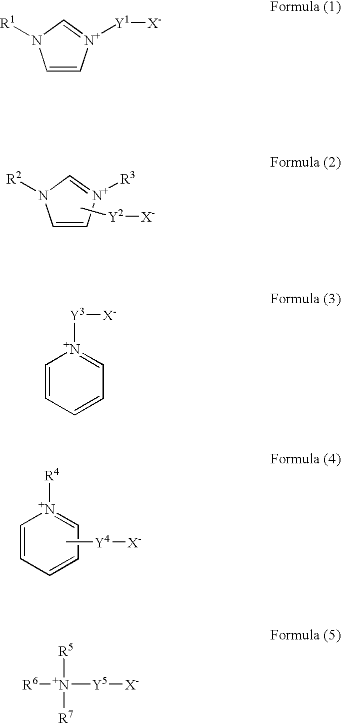

In the above formulas (1) to (5), R¹ to R⁷ may each be a hydrogen or a C₁₋₂₀ group which may contain one or more hetero atoms.

Further, Y¹ to Y⁵ may each be a C₁₋₂₀ group, which may contain one or more hetero atoms and connects a cation site and an anion site together via a covalent bond in the zwitterion salt.

As X⁻, a sulfonic acid anion (—SO₃⁻), sulfonylimido anion (—SO₂N⁻SO₂), sulfonylmethide acid ((—SO₂)₃C⁻) or carboxylic acid anion (—COO⁻) can be mentioned.

Preferably, the zwitterion salt represented by the formulas (1) to (5) may have a cationic structure composed of imidazole, pyridine and/or an ammonium salt, each of which contains a quaternary nitrogen. Specifically, the zwitterion salt can be imidazolium 1-methyl-3-propylsulfonate (MeImPrSO₃) represented by the below-described structural formula (1), imidazolium 1-hydro-3-propylsulfonate (HImPrSO₃) represented by the below-described structural formula (2), imidazolium 1,3-dimethyl-4-propylsulfonate represented by the below-described structural formula (3), pyridinium 1-propylsulfonate represented by the below-described structural formula (4), pyridinium 1-methyl-4-propylsulfonate represented by the below-described structural formula (5), and triethylpropylsulfonamide represented by the below-described structural formula (6).

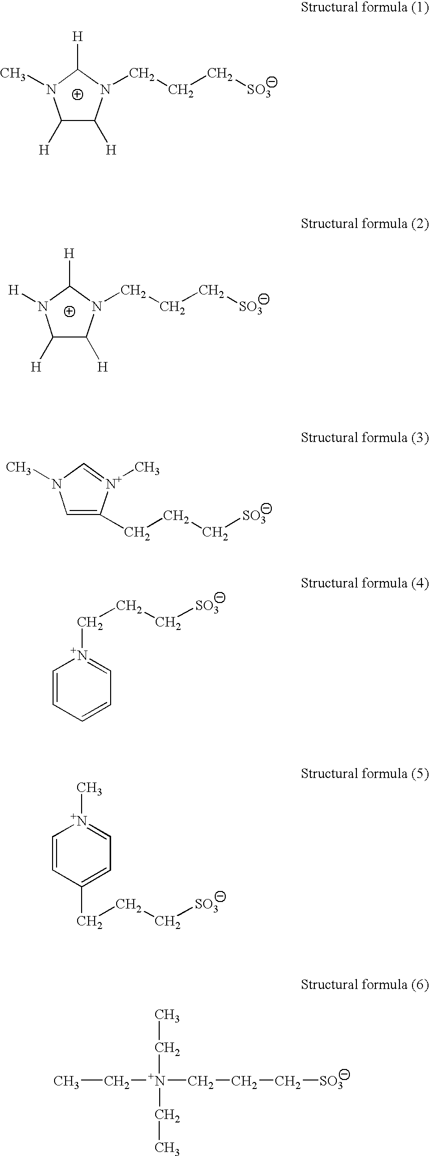

The proton donor may preferably include a carboxylic acid, a sulfonic acid, a sulfonylimidic acid, a sulfonylmethide acid, or a resin containing these acidic groups. Described specifically, the proton donor may preferably include bis(trifluoromethanesulfonylimide) hydride (HTFSI) represented by the below-described structural formula (7), a perfluorosulfonic acid resin (“Nafion” (registered trademark) or the like), trifluoromethanesulfonic acid, hexafluoroethanesulfonic acid, trifluoroacetic acid, trimethylsulfonic acid, acetic acid, phosphoric acid, or polystyrnesulfonic acid.

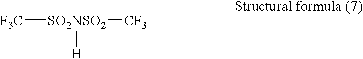

It is to be noted that the zwitterion salt may be mixed preferably in an equimolar or less amount with the proton donor although no particular limitation is imposed on the mixing ratio of the zwitterion salt to the proton donor.

As the mechanism of the conduction of protons in the proton conductor based on the present invention, it is considered that each proton (H⁺) moves between its adjacent zwitterion salt and proton donor via X⁻ of the zwitterion salt and the conduction of the proton is effected by repeating such a proton movement.

As described above, the proton conductor according to the present invention includes the zwitterion salt and the proton donor, and the zwitterion salt acts as a proton-conducting carrier to achieve the conduction of protons. As the conduction of protons by the use of the zwitterion salt does not require water specifically, the proton conductor can operate as an electrochemical device such as a fuel cell even in a dry state or under non-humidified conditions of high temperature, for example, 100° C. Complex equipment such as a humidifier, therefore, becomes no longer needed, thereby making it possible to simplify a system and to realize the portabilization of an electrochemical device such as a fuel cell.

The electrochemical device according to the present invention can be constructed, for example, as a fuel cell.

With reference to the drawings, a detailed description will hereinafter be made about an embodiment of the present invention.

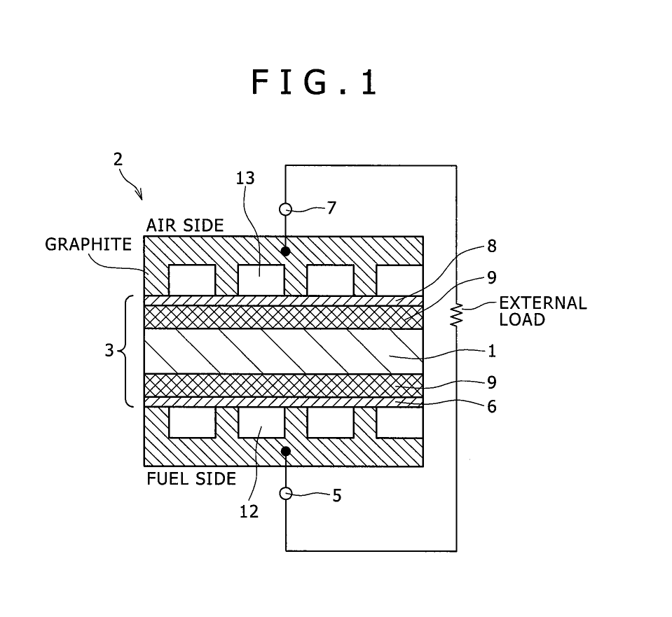

FIG. 1 is a schematic cross-sectional view of one example of the electrochemical device according to the present invention as constructed as a fuel cell. In other words, this drawing illustrates an example of the electrochemical device according to the present invention as applied to a fuel cell in which fuel is fed to the first electrode and oxygen is fed to the second electrode.

This fuel cell 2 has a stacked layer structure (MEA) 3 formed of an anode (fuel cell) 6 equipped with a terminal 5, a cathode (oxygen electrode) 8 equipped with a terminal 7, said anode and said cathode being arranged opposite to each other, and a proton conducting layer 1 held between these electrodes. Further, the anode 6 and cathode 8 are provided with catalyst layers 9, respectively.

As an illustrative process for the production of the MEA 3, the zwitterion salt and the proton donor are mixed together with a solvent, and the resulting mixture is cast into a membrane by the doctor blade method or the like. The membrane prepared as described above is then held between the electrodes 6, 8 equipped with the catalyst layers 9, respectively, and hot pressing (for example, 150° C., 0.1 t, five minutes) is performed to produce the MEA 3.

A description will next be made of the mechanism of this fuel battery 2. Upon use, H₂ gas is fed through H₂ gas flow channels 12 on the side of the anode 6. While the fuel (H₂ gas) passes through the flow channels 12, hydrogen ions are produced at the anode 6 and these hydrogen ions move toward the cathode 8 through the proton conducting layer 1. On the other hand, electrons released upon the ionization pass through an external circuit and moves toward the cathode 8. At the cathode 8, the hydrogen ions and electrons react with oxygen (air) fed through O₂ channels 13, and as a result, a desired electromotive force is produced.

A plurality of stacked layer structures (MEAs) 3, each of which is formed of the anode 6 provided with the catalyst layer 9, the proton conducting layer 1 and the cathode 8 provided with the catalyst 9, may be stacked together into an integral structure. This construction has an advantageous effect that a still higher electromotive force can be readily obtained. Although the description has been made about the example which uses H₂ gas as fuel, other fuel can be used obviously.

As the proton conducting layer 1 in the fuel cell 2 includes the proton conductor according to the present invention, the zwitterion salt acts as a conduction carrier for protons and realizes the conduction of protons. The proton conductor, which makes use of the zwitterion salt, can operate as a fuel cell even in a dry state or under non-humidified conditions of high temperature, for example, 100° C. without specifically needing water. Complex equipment such as a humidifier is, therefore, no longer needed, thereby making it possible to simplify a system and to realize portabilization of an electrochemical device such as a fuel battery.

The present invention will hereinafter be described based on examples.

### EXAMPLE 1

Using imidazolium 1-methyl-3-propylsulfonate (MeImPrSO₃) as the zwitterion salt and bis(trifluoromethanesulfonylimide) hydride (HTFSI) as the proton donor, a differential scanning calorimetry (DSC) measurement, ¹H-NMR and ion conductivity measurement were conducted to determine whether or not the above-described mixed system of the zwitterion salt and the proton donor functions as a proton conducting layer.

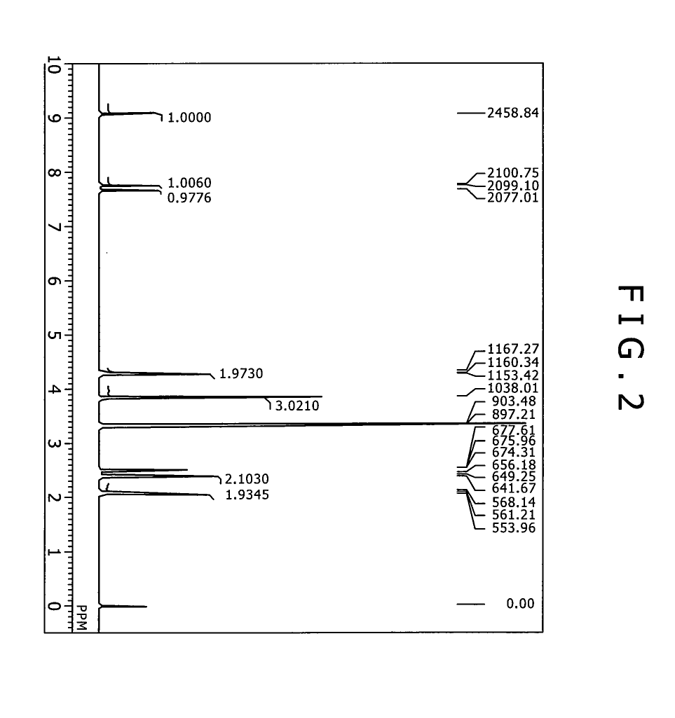

MeImPrSO₃ was prepared as will be described below. Firstly, 1,3-propanesultone was slowly added dropwise to a solution of N-methylimidazole in acetone. When the resulting mixture was stirred at room temperature for one day, a white precipitate was formed. Subsequent to the reaction, the reaction mixture was filtered to remove the liquid components. The precipitate was repeatedly washed with acetone, and was then dried to obtain a white powdery substance. ¹H-NMR was conducted on the thus-obtained substance. As a result, the substance was identified as MeImPrSO₃, the target product, as shown in FIG. 2.

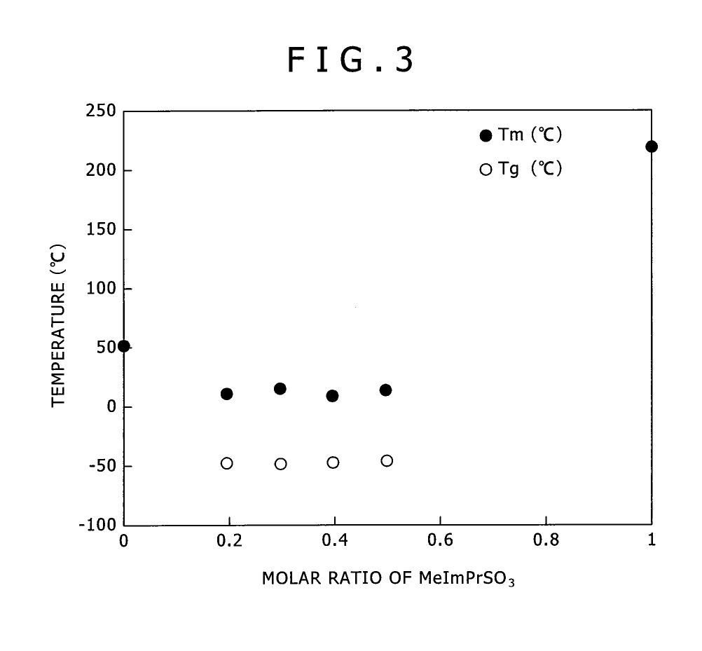

On liquids each obtained by mixing MeImPrSO₃, which had been prepared as described above, with HTFSI, a differential scanning calorimetry (DSC) measurement was conducted. As a result, glass transition temperatures (Tg) appeared around about −50° C. as shown in FIG. 3. The mixing ratio (molar ratio) of MeImPrSO₃ to HTFSI was varied from 0 to 0.5.

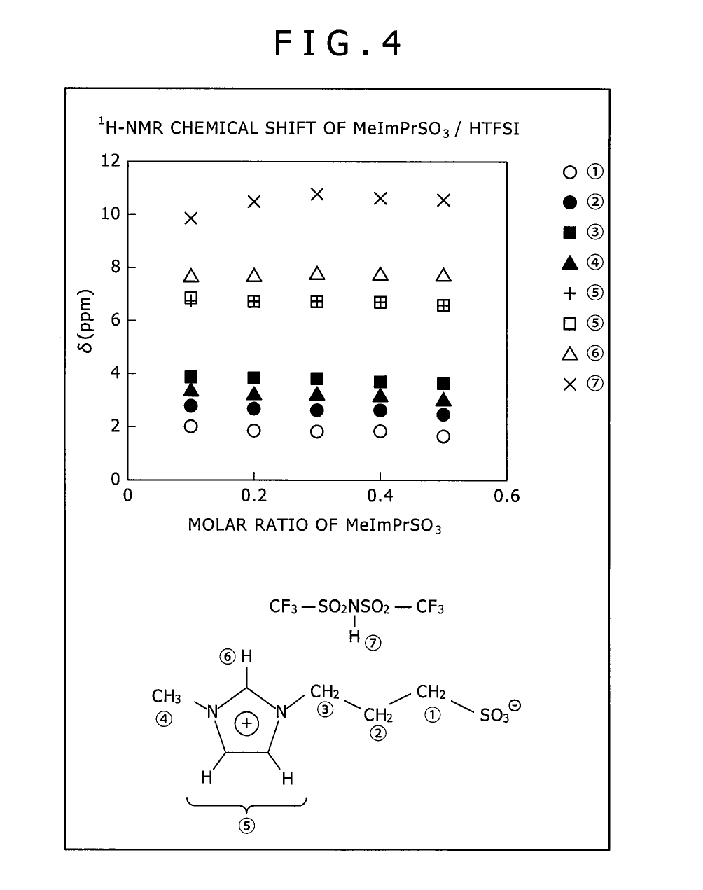

Further, the molar ratio of MeImPrSO₃ to HTFSI was varied to 1/9, 2/8, 3/7, 4/6 and 5/5 (MeImPrSO₃/HTFSI) to investigate a chemical shift of the proton in HTFSI when the composition was modified. The measurement was conducted by using a double-wall tube to avoid interaction with the NMR solvent and placing the NMR solvent in an inner tube and each sample in an outer tube. As shown in FIG. 4, it has been ascertained that with the ratio of MeImPrSO₃, the proton of HTFSI shifts toward a lower magnetic field and is provided with higher dissociability.

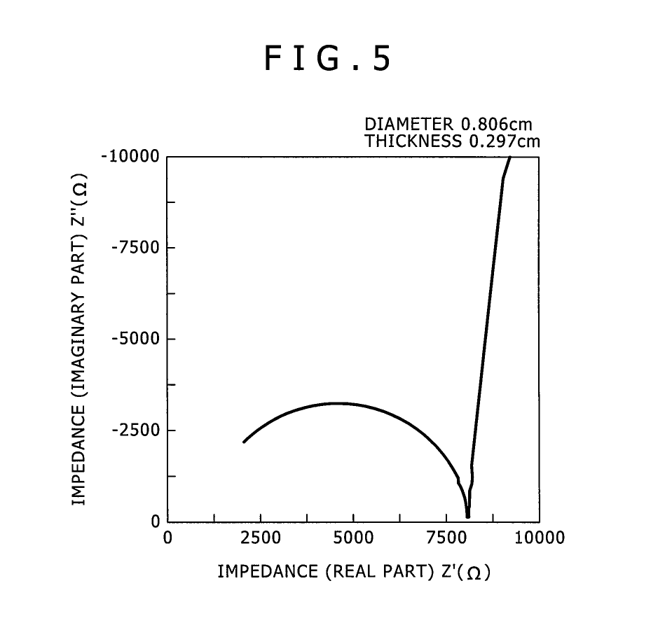

In addition, the molar ratio of MeImPrSO₃ to HTFSI was changed to 5/5 (MeImPrSO₃/HTFSI), and on the resultant proton conductor, its ion conductivity was measured under a dry atmosphere. FIG. 5 is a Cole-Cole plot of the sample at room temperature (25° C.). From the Cole-Cole plot of FIG. 5, the ion conductivity was determined to be 7×10⁻⁵ S/cm.

### EXAMPLE 2

Imidazolium 1-hydro-3-propylsulfonate (HImPrSO₃) of the type that the N-site of the zwitterion salt is hydrogen was used. It was mixed with HTFSI as the above-described proton donor, and the resulting proton conductor was investigated for proton conductivity.

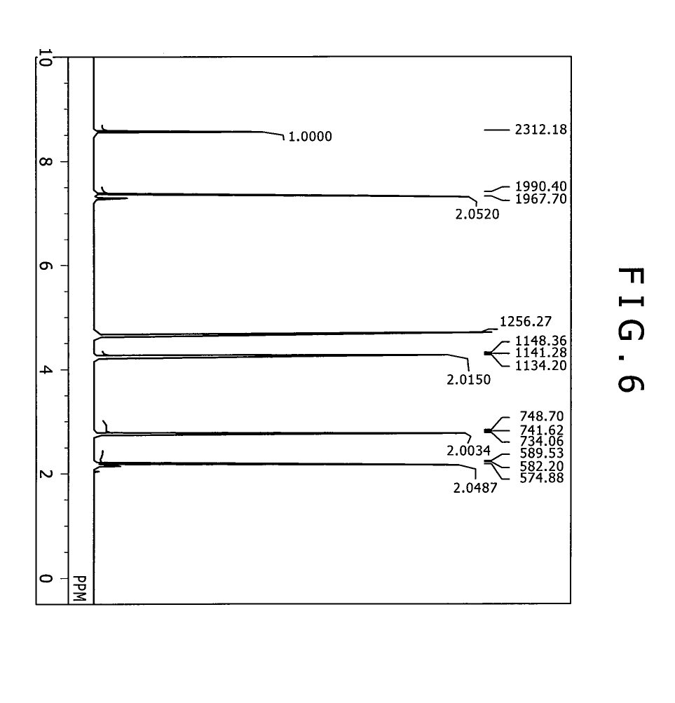

HImPrSO₃ was prepared as will be described below. Firstly, 1,3-propanesultone was slowly added dropwise to a solution of imidazole in acetone. When the resulting mixture was stirred at room temperature for one day, a white precipitate was formed. Subsequent to the reaction, the reaction mixture was filtered to remove the liquid components. The precipitate was repeatedly washed with acetone, and was then dried to obtain a white powdery substance. ¹H-NMR was applied to the thus-obtained substance. As a result, the substance was identified as HImPrSO₃, the target product, as shown in FIG. 6.

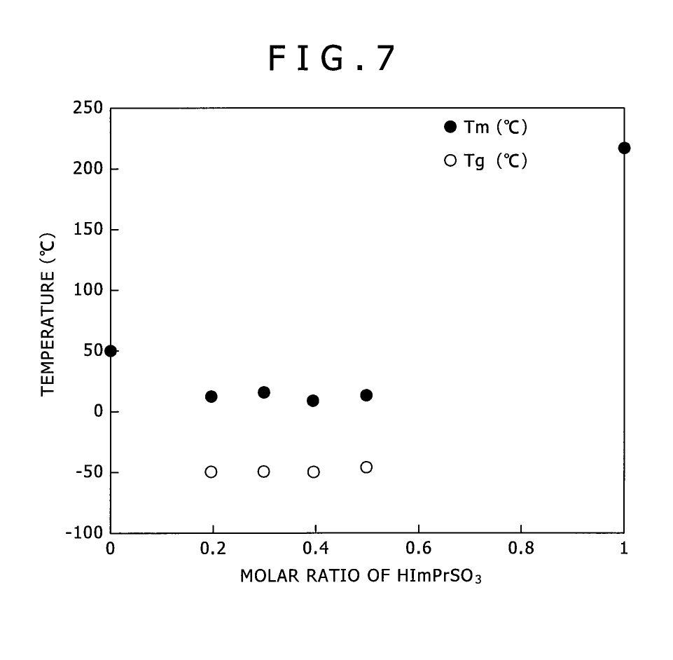

On liquids each obtained by mixing HImPrSO₃, which had been prepared as described above, with HTFSI, a differential scanning calorimetry (DSC) measurement was conducted. As a result, glass transition temperatures (Tg) appeared around about −50° C. as shown in FIG. 7. The mixing ratio (molar ratio) of HImPrSO₃ to HTFSI was varied from 0 to 0.5.

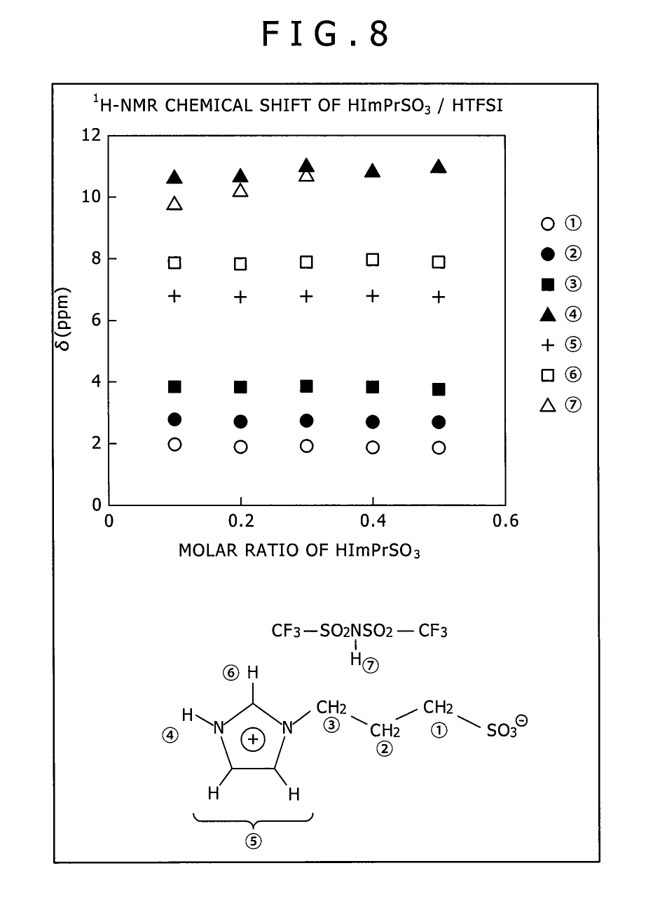

Further, the molar ratio of HImPrSO₃ to HTFSI was varied to 1/9, 2/8, 3/7, 4/6 and 5/5 (HImPrSO₃/HTFSI) to investigate a chemical shift of the proton in HTFSI when the composition was modified. The measurement was conducted by using a double-wall tube to avoid interaction with the NMR solvent and placing the NMR solvent in an inner tube and each sample in an outer tube. As shown in FIG. 8, it has been ascertained that with the ratio of HImPrSO₃, the proton of HTFSI shifts toward a lower magnetic field and is provided with higher dissociability.

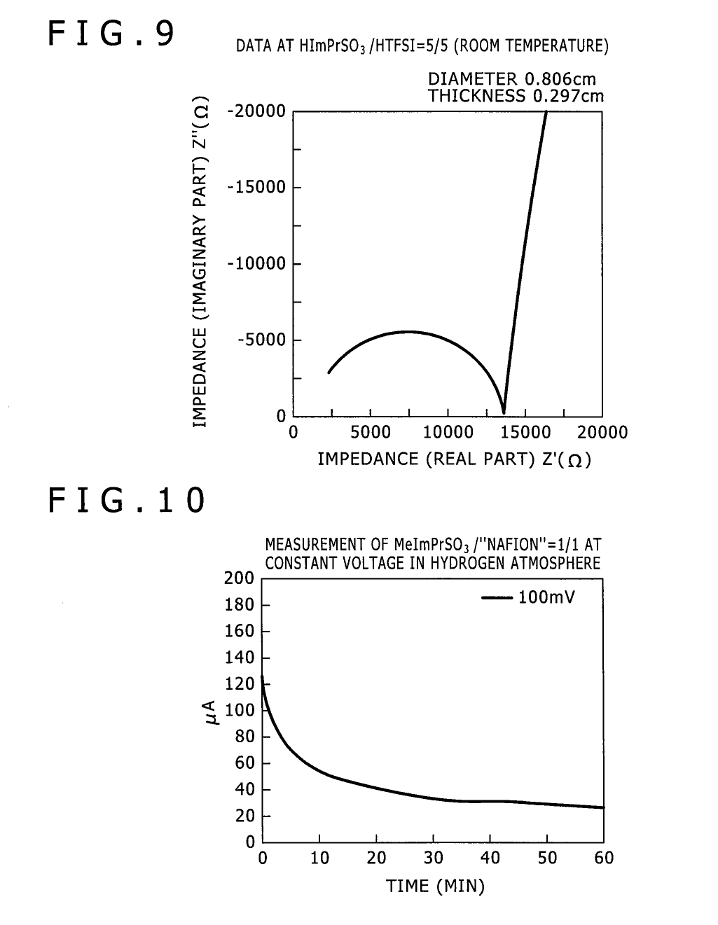

In addition, the molar ratio of HImPrSO₃ to HTFSI was changed to 5/5 (HImPrSO₃/HTFSI), and on the resultant proton conductor, its ion conductivity was measured under a dry atmosphere. FIG. 9 is a Cole-Cole plot of the sample at room temperature (25° C.). From the Cole-Cole plot of FIG. 9, the ion conductivity was determined to be 4×10⁻⁵ S/cm.

### EXAMPLE 3

Using a proton conductor according to the present invention which was formed of the zwitterion salt and the proton donor, a proton conducting layer was prepared as described above, and its assessment was performed. Employed as the zwitterion salt and the proton donor were MeImPrSO₃ and a solution of “Nafion” (trademark).

Firstly, MeImPrSO₃ was added to the solution of “Nafion” (trademark). Subsequent to stirring for three hours, the resulting mixture was cast by the doctor blade method into a membrane of 250 μm thick. It is to be noted that the mixing ratio of “Nafion” (trademark) to MeImPrSO₃ was set at 1/1 (“Nafion” (trademark)/MeImPrSO₃).

A 1/1 mixed solution of “Nafion” (trademark) and MeImPrSO₃ was next coated on a platinum-carrying carbon (carried platinum: 1 mg/cm², product of ElectroChem, Inc., trade name “Valcan XC-72”), followed by drying at 60° C. for three hours to prepare electrodes. The above-prepared membrane was held between the electrodes, and hot-pressing (150° C., 0.1 t, five minutes) was then performed to prepare a MEA. The MEA was placed under a hydrogen atmosphere in a box, and was heated to 120° C. to perform a measurement at a constant voltage. As shown in FIG. 10, a current of 3.5 mA flowed when a voltage of 100 mV was applied. At that time, the ion conductivity was 2×10⁻³ S/cm.

As is clearly appreciated from the foregoing, the proton conductor according to the present invention includes the zwitterion salt and the proton donor, and the zwitterion salt acts as a proton-conducting carrier to achieve the conduction of protons. As the conduction of protons by the use of the zwitterion salt does not require water specifically, the proton conductor can operate as a fuel cell even in a dry state or under non-humidified conditions of high temperature, for example, 100° C. Complex equipment such as a humidifier, therefore, becomes no longer needed, thereby making it possible to simplify a system and to realize the portabilization of an electrochemical device such as a fuel cell.

The present invention has been described based on the embodiment and examples. It is, however, to be noted that the above-described embodiment and examples can be modified in various ways based on the technical concept of the present invention.

For example, in the electrochemical device according to the present invention which is suited as a fuel cell or the like, its shape, construction, materials and the like can be modified as desired insofar as such modifications do not depart from the present invention.

Industrial Applicability

The proton conductor according to the present invention includes the zwitterion salt and the proton donor. In place of water in the conventional art, the zwitterion salt acts as a proton-conducting carrier to achieve the conduction of protons. As the conduction of protons by the use of the zwitterion salt does not require water specifically, the proton conductor can operate as an electrochemical device such as a fuel cell even in a dry state or under non-humidified conditions of high temperature, for example, 100° C. Complex equipment such as a humidifier, therefore, becomes no longer needed, thereby making it possible to simplify a system and to realize the portabilization of an electrochemical device such as a fuel cell.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-10. (canceled)

11. A proton conductor comprising a zwitterion salt and a proton (H⁺) donor.

12. The proton conductor according to claim 11, wherein said zwitterion salt is a fusible salt represented by the following formulas (1) to (5):

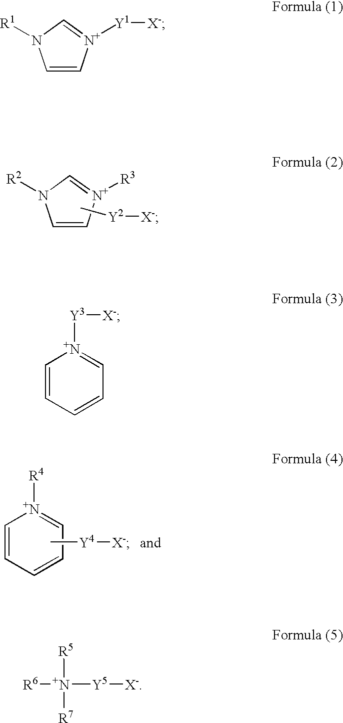

13. The proton conductor according to claim 12, wherein in the formulas (1) to (5), R¹ to R⁷ are each a hydrogen or a C₁₋₂₀ group which may contain one or more hetero atoms.

14. The proton conductor according to claim 12, wherein in the formulas (1) to (5), Y¹ to Y⁵ are each a C₁₋₂₀ group, which may contain one or more hetero atoms and connects a cation site and an anion site together via a covalent bond in said zwitterion salt.

15. The proton conductor according to claim 12, wherein X⁻ is a sulfonic acid anion (—SO₃⁻), sulfonylimido anion (—SO₂N⁻SO₂), sulfonylmethide acid ((—SO₂)₃C⁻) and carboxylic acid anion (—COO⁻).

16. The proton conductor according to claim 12, wherein said zwitterion salt represented by said the formulas (1) to (5) has a cationic structure composed of imidazole, pyridine and/or an ammonium salt, each of which contains a quaternary nitrogen.

17. The proton conductor according to claim 11, wherein said proton donor is selected from the group consisting of a carboxylic acid, a sulfonic acid, a sulfonylimidic acid, a sulfonylmethide acid, and a resin thereof.

18. The proton conductor according to claim 11, wherein said zwitterion salt is mixed in a proportion equimolar to said proton donor.

19. An electrochemical device having a stacked layer structure formed of a first electrode, a second electrode and a proton conducting layer held between said electrodes, wherein said proton conducting layer comprises a proton conductor including zwitterions salt and proton (H⁺) donor.

20. The electrochemical device according to claim 19, which is constructed as a fuel cell.
